(19) United States
(12) Patent Application Publication
(10) Pub. No.: US 2026/0023579 A1
(43) Pub. Date: Jan. 22, 2026

(54) REAL-TIME ADAPTIVE WALLPAPERS USING MULTI-SENSORY DATA

(71) Applicant: Samsung Electronics Co., Ltd., Suwon-si (KR)

(72) Inventors: Umar Khalid, Belmont, MA (US); Laszlo Gombos, Winchester, MA (US); Winston Chen, Winchester, MA (US)

(21) Appl. No.: 19/248,163

(22) Filed: Jun. 24, 2025

Related U.S. Application Data
(60) Provisional application No. 63/674,194, filed on Jul. 22, 2024.

(51) Int. Cl. G06F 9/451

(52) U.S. Cl. CPC G06F 9/451

(57) ABSTRACT

A method includes obtaining a multimodal input using at least one sensor and converting the multimodal input into encoded features. The method also includes adjusting the encoded features to produce machine learning (ML) outputs based on user profiles, web browser data, and behavior patterns using an ML model. The method further includes generating text prompts based on the ML outputs using an on-device large language model (LLM) and generating a 360° multimodal wallpaper based on the text prompts from the on-device LLM using one or more generative models. The method also includes refining the text prompts from the on-device LLM based on ongoing sensor data and user interaction using a feedback loop between an output of the one or more generative models and the on-device LLM.

### CROSS-REFERENCE TO RELATED APPLICATIONS AND CLAIM OF PRIORITY

The present application claims priority to U.S. Provisional Patent Application No. 63/674,194, filed on Jul. 22, 2024. The contents of the above-identified patent documents are incorporated herein by reference.

### TECHNICAL FIELD

This disclosure relates generally to virtual reality systems and processes. More specifically, this disclosure relates systems and methods for generating real-time adaptive 360° wallpapers using multi-sensory data and contextualized multimodal prompt generation for cross-modality content creation.

### BACKGROUND

Generative AI models are used in virtual reality and augmented reality to generate environments, objects, characters, and other environmental features to provide a user with a desired experience. These generative AI models may be implemented using various user devices, including headsets, to immerse a user into an environment. These VR or AR devices includes multiple sensors configured to receive environmental data as well as inputs, both passive and active, from the user. However, current implementations of generative AI models do not incorporate device sensors as an input. Accordingly, there is a need for systems and methods for cross-modality content generation that overcome these challenges.

### SUMMARY

The present disclosure relates generally to systems and methods for generating real-time adaptive wallpapers using multi-sensory data and contextualized multimodal prompt generation for cross-modality content creation.

In one embodiment, a method is provided. The method includes obtaining, by at least one processing device of an electronic device, a multimodal input using at least one sensor, and converting the multimodal input into encoded features. The method also includes adjusting the encoded features, by the at least one processing device of the electronic device, to produce machine learning (ML) outputs based on user profiles, web browser data, and behavior patterns using an ML model. The method further includes generating text prompts, by the at least one processing device of the electronic device, based on the ML outputs using an on-device large language model (LLM) and generating a 360° multimodal wallpaper based on the text prompts from the on-device LLM using one or more generative models. The method also includes refining the text prompts from the on-device LLM, by the at least one processing device of the electronic device, based on ongoing sensor data and user interaction using a feedback loop between an output of the one or more generative models and the on-device LLM.

In another embodiment, a virtual reality generation system is provided. The virtual reality generation system includes an electronic device including a processor, the processor configured to cause the electronic device to obtain a multimodal input using at least one sensor, convert the multimodal input into encoded features, adjust the encoded features to produce ML outputs based on user profiles, web browser data, and behavior patterns using an ML model, generate text prompts based on the ML outputs using an on-device LLM, generate a 360° multimodal wallpaper based on the text prompts from the on-device LLM using one or more generative models, and refine the text prompts from the on-device LLM based on ongoing sensor data and user interaction using a feedback loop between an output of the one or more generative models and the on-device LLM.

In yet another embodiment, a non-transitory computer-readable medium is provided. The non-transitory computer-readable medium includes program code, that when executed by at least one processor of an electronic device, causes the electronic device to obtain a multimodal input using at least one sensor, convert the multimodal input into encoded features, adjust the encoded features to produce ML outputs based on user profiles, web browser data, and behavior patterns using an ML model, generate text prompts based on the ML outputs using an on-device LLM, generate a 360° multimodal wallpaper based on the text prompts from the on-device LLM using one or more generative models, and refine the text prompts from the on-device LLM based on ongoing sensor data and user interaction using a feedback loop between an output of the one or more generative models and the on-device LLM.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit”, “receive”, and “communicate”, as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have”, “may have”, “include”, or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B”, “at least one of A and B”, and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for”, “having the capacity to”, “designed to”, “adapted to”, “made to”, or “capable of” depending on the circumstances. The phrase “configured (or set) to” does not essentially mean “specifically designed in hardware to”. Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a”, “an”, and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device”, “unit”, “component”, “element”, “member”, “apparatus”, “machine”, “system”, “processor”, or “controller”, within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example network configuration including an electronic device according to an embodiment of the present disclosure;

FIG. 2 illustrates an example system according to an embodiment of the present disclosure;

FIG. 3 illustrates a block diagram of an example virtual reality generation system according to an embodiment of the present disclosure;

FIG. 4 illustrates a block diagram of an example virtual reality generation system according to an embodiment of the present disclosure;

FIG. 5 illustrates a block diagram of an example virtual reality generation system according to an embodiment of the present disclosure; and

FIG. 6 illustrates an example method for generating real-time adaptive 360° wallpapers using multi-sensory data and contextualized multimodal prompt generation according to an embodiment of the present disclosure.

### DETAILED DESCRIPTION

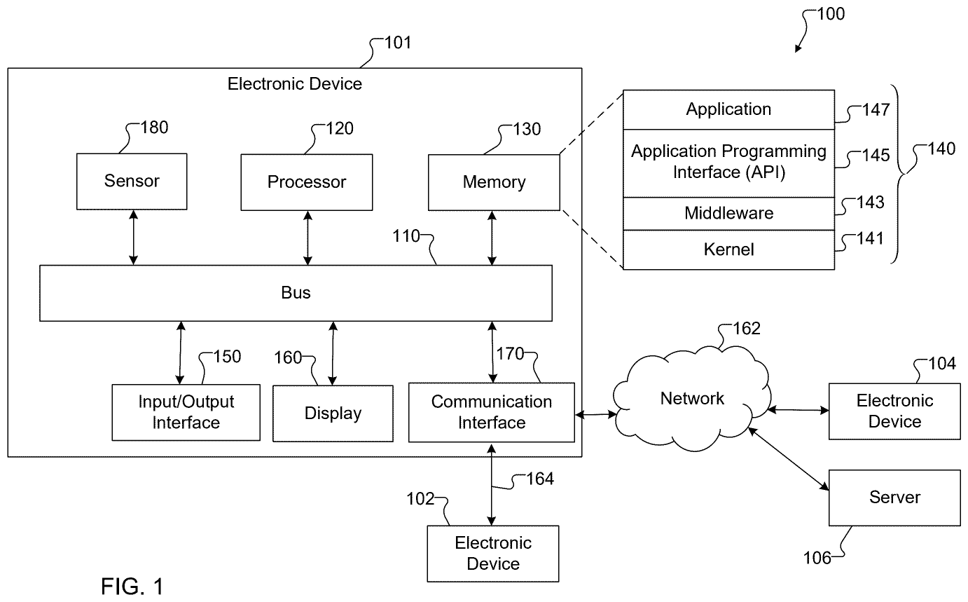

FIG. 1 through FIG. 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As introduced above, generative AI models are used in virtual reality and augmented reality to generate environments, objects, characters, and other environmental features to provide a user with a desired experience. These generative AI models may be implemented using various user devices, including headsets, to immerse a user into an environment. These extended reality (XR) devices include multiple sensors configured to receive environmental data as well as inputs, both passive and active, from the user. However, current implementations of generative AI models do not incorporate device sensors as an input.

With XR headsets having the capability to connect to other devices (such as smartwatches and smart phones) to provide sensor information to the headset, data from the connected devices may be used as input to generative AI models to generate XR features, such as a 360° wallpaper configured to help with regulating a mood and emotions of a user or to provide a better personal wallpaper.

Traditional XR wallpapers fail to adapt dynamically to the current emotions and environmental contexts of a user, creating a gap in integrating the digital experiences of a user with their immediate physical surroundings. Further, users often struggle with customizing digital content in traditional XR system to suit their evolving tastes and preferences. This results in a decrease in user engagement.

The present disclosure provides for systems and methods for generating real-time adaptive XR features (such as 360° wallpapers) using multi-sensory data and contextualized multimodal prompt generation for cross-modality content creation that overcome these challenges. In particular, the present disclosure provides a system that generates real-time adaptive 360° wallpapers using multi-sensory data by using an encoder layer configured to receive multimodal input from one or more sensors to generate encoded features, a machine learning layer to generate ML outputs from the encoded features, an on-board LLM to generate text prompts from the ML outputs, and one or more generative AI models to generate the XR features (such as the 360° wallpapers).

The methods and systems of the present disclosure leverage multi-sensory data to create immersive and personalized digital environments and dynamically adjust to emotional states, locations, and environmental conditions of a user by using inputs from various devices and sensors.

FIG. 1 illustrates an example network configuration 100 including an electronic device according to an embodiment of the present disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to fine-grained virtual reality wallpaper generation via external memory using neural sampling.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to fine-grained virtual reality wallpaper generation via external memory using neural sampling. These functions can be performed by a single application or by multiple applications that each conduct one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second external electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high-definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving a separate network. The electronic device 101 can also be an augmented reality wearable device, such as eyeglasses, which include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the second external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to fine-grained virtual reality wallpaper generation via external memory using neural sampling.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

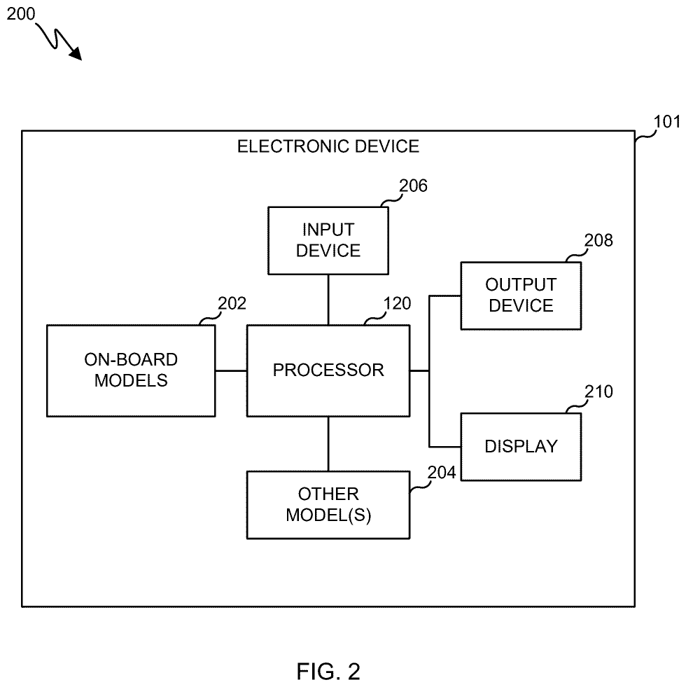

FIG. 2 illustrates an example system 200 according to an embodiment of the present disclosure. For case of explanation, the system 200 is described as involving the use of the electronic device 101 in the network configuration 100 of FIG. 1. However, the system 200 may be used with any other suitable device (such as the server 106) or a combination of devices (such as the electronic device 101 and the server 106) and in any other suitable system(s).

As shown in FIG. 2, the system 200 includes the electronic device 101, which includes the processor 120. The processor 120 is operatively coupled to or otherwise configured to use one or more machine learning models, such as a one or more on-board virtual reality generation models 202. As further described in this disclosure, the one or more on-board virtual reality generation models 202 can include various components and sub-models, such as a speech recognition model. The one or more on-board virtual reality generation models 202 can receive an input, and the one or more on-board virtual reality generation models 202 can operate to perform virtual reality wallpaper generation depending on the context or application. The one or more on-board virtual reality generation models 202 can generate an output used to perform an action by the electronic device 101 requested in the input.

The processor 120 can also be operatively coupled to or otherwise configured to use one or more other machine learning models 204, such as other models related to automated speech recognition or voice assistant processes. It will be understood that the machine learning models 204 can be stored in a memory of the electronic device 101 (such as the memory 130) and accessed by the processor 120 to perform automated speech recognition tasks, spoken language understanding tasks, and/or other tasks. However, the machine learning models 204 can be stored in any other suitable manner.

The system 200 also includes an input device 206 (such as a keyboard or microphone), an output device 208 (such as a speaker or headphones), and a display 210 (such as a screen or a monitor like the display 160). The processor 120 receives an input from the input device 206 and provides the input to the one or more on-board virtual reality generation models 202. The one or more on-board virtual reality generation models 202 processes the input and outputs a result to the processor 120. The processor 120 may instruct one or more further actions that correspond to one or more instructions or requests provided in the utterance.

Although FIG. 2 illustrates one example of a system 200, various changes may be made to FIG. 2. For example, in some embodiments, the input device 206, the output device 208, and the display 210 can be connected to the processor 120 within the electronic device 101, such as via wired connections or circuitry. In other embodiments, the input device 206, the output device 208, and the display 210 can be external to the electronic device 101 and connected via wired or wireless connections. Also, in some cases, the one or more on-board virtual reality generation models 202 and one or more of the other machine learning models 204 can be stored as separate models called upon by the processor 120 to perform certain tasks or can be included in and form a part of one or more larger machine learning models. Further, in some embodiments, one or more of the models, such as the one or more on-board virtual reality generation models 202 or one or more of the other machine learning models 204, can be stored remotely from the electronic device 101, such as on the server 106. Here, the electronic device 101 can transmit requests including inputs to the server 106 for processing of the inputs using the machine learning models, and the results can be sent back to the electronic device 101. In addition, in some embodiments, the electronic device 101 can be replaced by the server 106, which receives audio inputs from a client device and transmits instructions back to the client device to execute functions associated with instructions included in utterances.

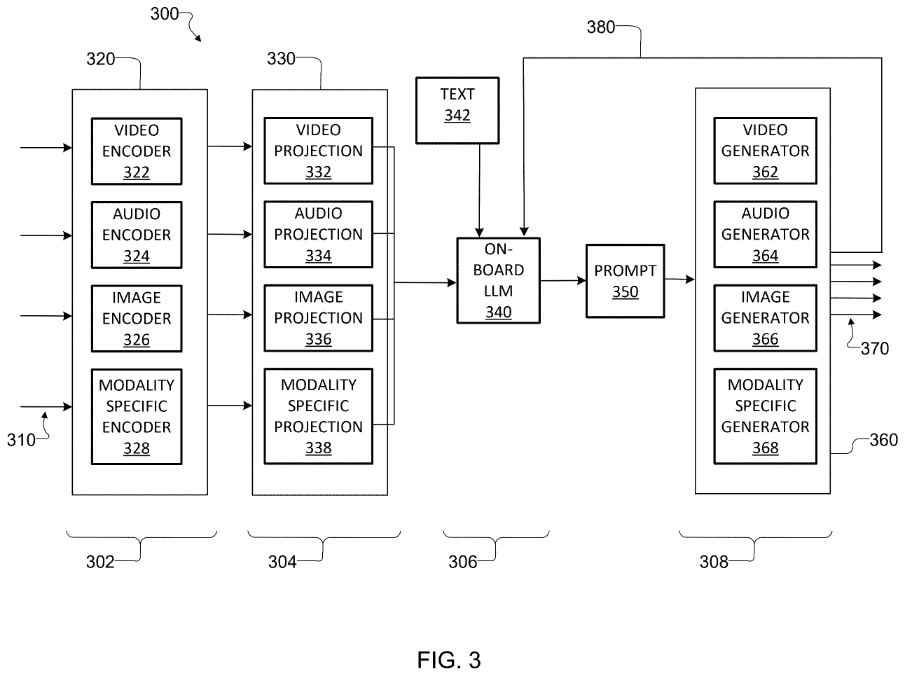

FIG. 3 illustrates a block diagram of an example virtual reality generation system 300 according to an embodiment of the present disclosure. In particular, the virtual reality generation system 300 may be used by the processor 120 of the electronic device 101 of FIG. 1 to perform virtual reality generation functions, e.g., in response to a query by a user or in operations by other applications.

As shown in FIG. 3, the virtual reality generation system 300 includes an encoding phase 302, an LLM-centric alignment phase 304, a prompt generation phase 306, and a multimodal output generation phase 308.

During the encoding phase 302, one or more multimodal inputs 310 are received by an encoder 320. The one or more multimodal inputs 310 may include GPS data, ambient light data, motion data, physiological sensor data, or other sensor data. The encoder 320 may include multiple encoders to process difference input modalities. For example, the encoder 320 may include a video encoder 322, an audio encoder 324, an image encoder 326, and a modality-specific encoder 328 that each may encode based on their respective modalities (such as the video encoder 322 encoding video inputs and the audio encoder 324 encoding audio inputs). The modality-specific encoder 328 may be one or more encoders configured to encode specific modalities from multimodal inputs 310 received from other sensor types. For example, the modality-specific encoder 328 may encode sensor input from a temperature sensor, a light sensor, or other sensors configured to capture data from an environment. The encoder 320 then produces modality-specific encoded features that are input into an on-device ML model 330 during the LLM-centric alignment phase 304. The modality-specific encoded features may include feature vectors from the multimodal input 310, user preferences, and device usage behavior. To inject multimodal interpretation in the prompt generation phase 306, trainable ML models are used. The ML models are tuned to consider user preferences, web browser data, and behavior patterns inferred from usage of an electronic device to tailor LLM output (textual prompts) more accurately to individual needs and interests. The ML model 330 may include neural networks, such as transformers with cross-attention layers that enable alignment between feature vectors from different encoders, variational autoencoders, graph neural networks, multimodal fusion networks (such as tensor fusion networks, late fusion models, and adaptive fusion networks), multimodal diffusion models, or a combination thereof. As such, the on-device ML model 330 produces modality-specific projections to align the modality-specific encoded features to each other as well as to prepare the encoded features for processing in the prompt generation phase 306. The on-device ML model 330 is configured to integrating various sensor inputs to capture a comprehensive context for prompt creation, including environmental factors, user activity, and location data. The on-device ML model 330 may include multiple ML sub-models to process multiple modalities. For example, the on-device ML model 330 may include a video projection 332, an audio projection 334, an image projection 336, and a modality-specific projection 338. The ML sub-models are configured to receive and process the modality-specific encoded features and align the encoded features to produce ML outputs that may be used during the prompt generation phase 306. The on-device ML model 330 interprets multimodal content, effectively mirroring the complex way humans perceive and interact with the world through diverse sensory inputs.

During the prompt generation phase 306, the ML outputs are received by a LLM 340. The on-device LLM 340 takes in features from various modalities to output a textual prompt. The on-device LLM 340 may be fed with the ML output.

The on-device LLM 340 may also receive a one or more user text inputs 342. The one or more user text inputs 342 may be provided by a user to provide a query or further context for generating the virtual reality wallpaper. The one or more user text inputs 342 may be provided by manual input from a user (such as by using a keyboard) or through a separate natural language processing system configured to generate text from user audio input. The on-device LLM 340 then generates a text prompt 350 that is provided to one or more generative models 360 during the multimodal output generation phase 308. For example, the on-device LLM 340 may aggregate the feature vectors of the ML outputs to generate a text prompt 350 that states, “Create a Panorama image of a sun setting in the beach”. The text prompt 350 may describe the desired XR features (such as a 360° wallpaper) considering emotions by the use keywords reflecting detected emotions (such as “peaceful forest” for calm or “energetic cityscape” for excitement), incorporating references to detected activities (such as “workout equipment” for gym setting or “beachfront view” for relaxation), leverage location data to personalize the scene (such as local landmarks and natural landscapes), and adjust color palette and lighting effects based on ambient light levels. The on-device LLM 340 may also implement algorithms to dynamically adapt and refine the prompt generation process based on ongoing user interactions (such as using the text input 342) and sensor data inputs received.

The one or more generative models 360 are text-based generative models, such as diffusion models, which are fed with customized prompts for generative tasks, including, but not limited to, 360° wallpaper generation (such as for a virtual web browser), video synthesis, 3-D scene generation, or other XR features. The one or more generative models 360 then generates one or more multimodal outputs 370 based on the received text prompt 350 that are combined to create the desired XR feature, such as a wallpaper for a virtual web browser. The one or more generative models 360 include neural networks configured to generate various outputs from text input, such as text-to-image diffusion models. The multimodal outputs 370 may include multiple generative models, such as a video generator 362, an audio generator 364, an image generator 366, and a modality-specific generator 368, to generate different aspects of a virtual reality wallpaper. For example, the video generator 362 may generate a video to be played as part of the virtual reality wallpaper. The multimodal outputs 370 (or features thereof) may be provided back to the on-device LLM 340 as part of a feedback loop 380. For example, the generated multimodal outputs 370 may be provided to the on-device LLM 340 during a subsequent operation of the virtual reality generation system 300 to update aspects of a generated feature (such as a 360° wallpaper) rather than re-generating the entire feature. Aside from the multimodal outputs 370, the feedback loop 380 may also include engagement data from the electronic device regarding user engagement, such as how long the user spends with the output (based on the crafted input), if user interacts with the output (e.g., using a copy function), or how often the user uses the generated feature.

The virtual reality generation system 300 provides an on-device solution by extending the pre-trained LLM functionality to interpret multimodal sensor data in addition to textual input to generate the text prompts 350 that are used in the one or more generative models 360. This on-device solution takes in features from various modalities to output a prompt. The response from the on-device LLM 340 may either be presented to the user or fed directly to other textual conditioned generative models to generate other modalities. This allows the on-device LLM 340 to use diverse modalities (such as voice, text, images, and GPS data) to enrich prompt generation.

Although FIG. 3 illustrates a block diagram of an example virtual reality generation system 300, various changes may be made to FIG. 3. For example, various components and functions in FIG. 3 may be combined, further subdivided, replicated, or rearranged according to particular needs. Also, one or more additional components and functions may be included if needed or desired.

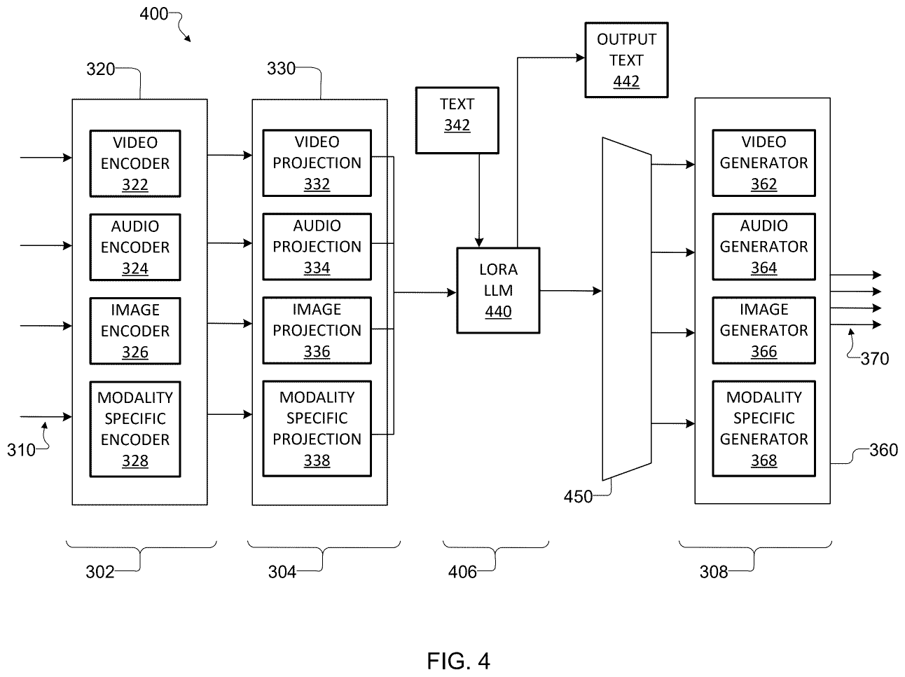

FIG. 4 illustrates a block diagram of an example virtual reality generation system 400 according to an embodiment of the present disclosure. In particular, the virtual reality generation system 400 may be used by the processor 120 of the electronic device 101 of FIG. 1 to perform virtual reality wallpaper generation functions, e.g., in response to a query by a user or in operations by other applications. The virtual reality generation system 400 is configured similarly to the virtual reality generation system 300 of FIG. 3, except as otherwise described.

As shown in FIG. 4, the virtual reality generation system 400 includes a task-specific fine tuning 406 after the LLM-centric alignment phase 304. In particular, the task-specific fine tuning 406 includes a low-rank adaptation (LoRA) LLM 440 that receives the ML outputs from the on-device ML model 330. The LoRA LLM 440 may generate an output text 442 as well as task-specific text prompts 450 upon receiving the ML outputs and, optionally, the one or more user text inputs 342. The LoRA LLM 440 is an LLM architecture enhanced with a mixture of experts (MoE). The MoE architectures uses multiple subnetworks (experts) that are each trained to process different types of inputs (such as video, audio, images, or other sensor inputs). The MoE architecture may include a gating network that decides which experts to activate based on given data. The LoRA architecture of the LoRA LLM 440 injects low-rank matrices into specific layers to reduce the number of trainable parameters while preserving performance. This combination allows the model to generate diverse and contextually rich prompts tailored for a variety of downstream tasks. By using the mixture of experts, each specialized in different aspects of prompt generation, the LoRA LLM 440 may dynamically select the most relevant prompts for a given task or input context, to not only enhance the flexibility and adaptability of the model but also improves quality and coherence.

A LoRA-MoE technique and its variants may be used to efficiently manage diverse tasks, ensuring scalability and adaptability across various modalities. The vocabulary of the LLM is expanded with specially designed, learnable task-specific tokens. These tokens appear in pairs, and the content between them represents the intermediate text prompt required for the corresponding modality-task.

For understanding tasks, text is directly output (such as with the output text 542). In the generation and editing scenarios, text prompts 350 are fed into the corresponding task model of the one or more generative models 360.

Although FIG. 4 illustrates a block diagram of an example virtual reality generation system 400, various changes may be made to FIG. 4. For example, various components and functions in FIG. 4 may be combined, further subdivided, replicated, or rearranged according to particular needs. Also, one or more additional components and functions may be included if needed or desired.

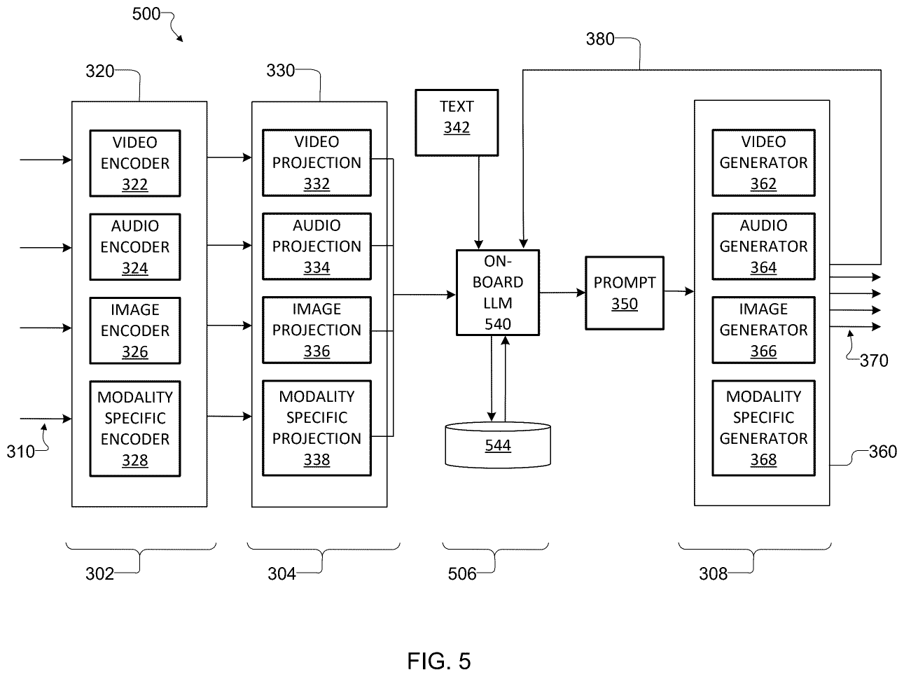

FIG. 5 illustrates a block diagram of an example virtual reality generation system 500 according to an embodiment of the present disclosure. In particular, the virtual reality generation system 500 may be used by the processor 120 of the electronic device 101 of FIG. 1 to perform virtual reality wallpaper generation functions, e.g., in response to a query by a user or in operations by other applications. The virtual reality generation system 500 is configured similarly to the virtual reality generation system 300 of FIG. 3, except as otherwise described.

As shown in FIG. 5, the virtual reality generation system 400 includes a prompt generation phase 506 after the LLM-centric alignment phase 304. In particular, the prompt generation phase 506 includes an on-board LLM 540 that receives the ML outputs from the on-device ML model 330. The on-board LLM 540, upon receiving the ML outputs, the one or more user text inputs 342, or other input before generating the text prompt 350, may perform a lookup function with a prompt database 544 operatively coupled to the on-board LLM 540. The prompt database 544 includes one or more prompt modifiers that indicate particular weights for prompt words.

In deep learning, text-to-image generation systems can generate digital images from text prompts. To be effective, the text prompts need to be provided in a particular format to, for example, generate images with a certain style. This may be achieved by adding keywords and key phrases to the text prompt called prompt modifiers.

The prompt modifiers add keywords to help generate better prompts for generative AI models. A list of prompt modifiers may be generated based on user feedback and through understanding training data used for building the one or more generative models 360. These prompt modifiers may be aggregated and shared to users to create a starting point for building a prompt modifier list. The list of prompt modifiers may also be customized or expanded to other generative AI models.

Although FIG. 5 illustrates a block diagram of an example virtual reality generation system 500, various changes may be made to FIG. 5. For example, various components and functions in FIG. 5 may be combined, further subdivided, replicated, or rearranged according to particular needs. Also, one or more additional components and functions may be included if needed or desired.

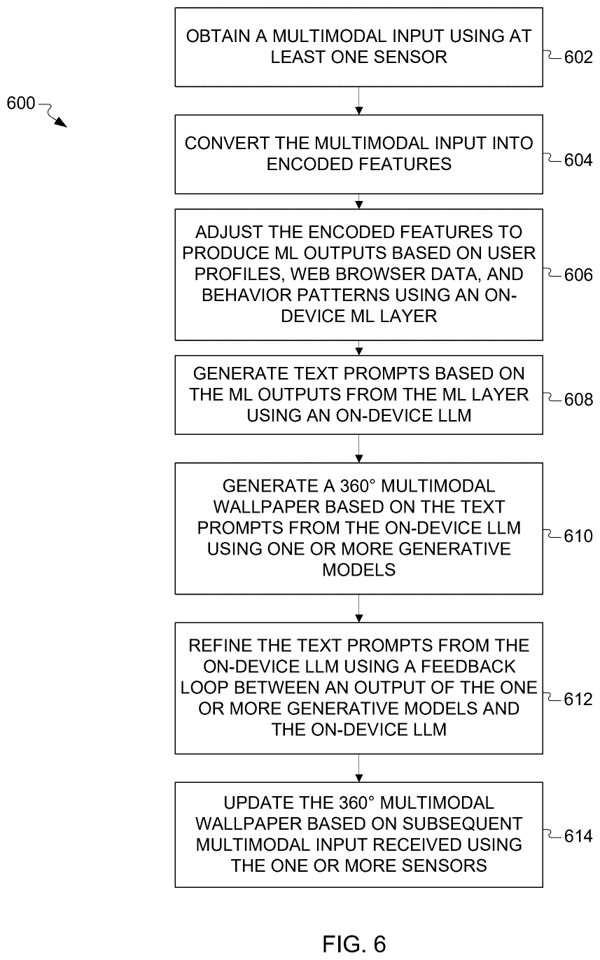

The virtual reality generation systems 300, 400, 500 may be used by a processor executing a method of virtual reality wallpaper generation in response to receiving sensor input or a user query on an electronic device. For example, the virtual reality generation system 300 may execute a method as shown in FIG. 6.

FIG. 6 illustrates a block diagram of an example method 600 for generating real-time adaptive 360° wallpapers using multi-sensory data and contextualized multimodal prompt generation according to an embodiment of the present disclosure. For ease of explanation, the method 600 is described as involving the use of the electronic device 101 in the network configuration 100 of FIG. 1 and the virtual reality generation system 300 of FIG. 3. However, the method 600 may be used with any other suitable electronic device (such as the server 106) or a combination of devices (such as the electronic device 101 and the server 106) and in any other suitable system(s).

A multimodal input is obtained using at least one sensor in step 602. For example, the multimodal inputs 310 may be input into the encoder 320 during the encoding phase 302. This may involve gathering various types of sensory data from the user. The multimodal inputs 310 may include environmental factors, user activity, or other contextual data points, and serve as the foundation for generating a personalized experience. For example, to generate adaptive wallpapers for VR headsets, data from smartphones and smartwatches may be harnessed by using GPS, ambient light, motion, and physiological sensors to capture the environment and state of the user.

The multimodal input is converted into encoded features using an encoder layer in step 604. For example, the encoder 320 may convert the multimodal inputs 310 into modality-specific encoded features. The encoder 320 may further convert the extracted features into tokens or embeddings, such as by mapping each feature into a low-dimensional space where similar features have similar representations. Each token may represent a specific aspect of the sensor data, capturing its essence in a format understandable by the model.

The encoded features are adjusted to produce ML outputs based on user profiles, web browser data, and behavior patterns using an on-device ML layer comprising an ML model in step 606. For example, the modality-specific encoded features may be processed in the on-device ML model 330 to produce ML outputs. The on-device ML model 330 fuses the multi-sensor data (features) to understand and interpret the current context, emotional state, location, or a combination thereof of the user.

Text prompts are generated based on the ML outputs from the ML layer using an on-device LLM in step 608. For example, the on-device LLM 340 may generate the text prompt 350 using the ML outputs. To do so, the on-device LLM 340 may aggregate the feature vectors of the ML outputs. This may include, for example, receiving one or more user text inputs 342 from a user and using the on-device LLM 340 to generate the text prompts 350 based on the one or more user text inputs 342 and the ML outputs.

An XR feature (such as a 360° multimodal wallpaper) is generated based on the text prompts from the on-device LLM using one or more generative models in step 610. For example, the text prompt 350 from the on-device LLM 340 is provided to the one or more generative models 360 to generate the multimodal outputs 370, such as a 360° wallpaper for a virtual web browser. This may include inputting the text prompts 350 into at least one of the one or more generative models 360 based on an output modality requested in the one or more user text inputs 342, the ML outputs, or both. In other words, the text prompt 350 may be fed to any text-based generative model (e.g., stable diffusion models) to generate content, such as a 360° wallpaper, animated character, video, audio, music, or a combination thereof.

The text prompts are refined from the on-device LLM based on ongoing sensor data and user interaction using a feedback loop between an output of the one or more generative models and the on-device LLM in step 612. For example, the multimodal outputs 370 may be provided to the on-device LLM 340 using a feedback loop 380 to refine the text prompt 350.

The XR feature (such as the 360° multimodal wallpaper) is updated based on subsequent multimodal input received using the one or more sensors in step 614. For example, once the multimodal outputs 370 are generated, the encoder 320 may receive subsequent multimodal inputs 310. The virtual reality generation system 300 will then modify the previous multimodal outputs 370 based on the subsequent multimodal inputs 310 to generate subsequent multimodal outputs 370. The subsequent multimodal outputs 370 are provided to update the generated wallpaper or other virtual features. This allows the generation of adaptive wallpapers based on multi-sensory data.

Although FIG. 6 illustrates one method 600 for generating real-time adaptive 360° wallpapers using multi-sensory data and contextualized multimodal prompt generation, various changes may be made to FIG. 6. For example, while shown as a series of steps, various steps in FIG. 6 could overlap, occur in parallel, occur in a different order, or occur any number of times.

The present disclosure provides for a systems and methods for generating real-time adaptive XR features (such as 360° wallpapers in a virtual web browser) using multi-sensory data and contextualized multimodal prompt generation that create a more immersive and personalized digital experience that is empathetically aligned with the emotional state and environmental context of the user. By using a variety of sensory inputs gathered from personal devices and sensors, the present disclosure enables dynamic generation of XR features (such as digital wallpapers in a virtual web browser) that not only visually enrich the digital environment but also adapt in real-time to reflect the immediate surroundings and emotional state of a user. As a result, the systems and methods of this disclosure enhance user engagement and emotional connection through a customizable and contextually-aware digital backdrop.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
obtaining, by at least one processing device of an electronic device, a multimodal input using at least one sensor;
converting the multimodal input, by the at least one processing device of the electronic device, into encoded features;
adjusting the encoded features, by the at least one processing device of the electronic device, to produce machine learning (ML) outputs based on user profiles, web browser data, and behavior patterns using an ML model;
generating text prompts, by the at least one processing device of the electronic device, based on the ML outputs using an on-device large language model (LLM);
generating a 360° multimodal wallpaper, by the at least one processing device of the electronic device, based on the text prompts from the on-device LLM using one or more generative models; and
refining the text prompts from the on-device LLM, by the at least one processing device of the electronic device, based on ongoing sensor data and user interaction using a feedback loop between an output of the one or more generative models and the on-device LLM.

2. The method of claim 1, further comprising:
updating, by the at least one processing device of the electronic device, the 360° multimodal wallpaper based on subsequent multimodal input received using the one or more sensors.

3. The method of claim 1, wherein the multimodal input comprises one or more of GPS data, ambient light data, motion data, and physiological sensor data.

4. The method of claim 1, wherein the encoded features comprises feature vectors from the multimodal input, user preferences, and device usage behavior.

5. The method of claim 4, wherein generating the text prompts comprises aggregating the feature vectors using the on-device LLM.

6. The method of claim 4, wherein generating the text prompts comprises:
receiving, by the at least one processing device of the electronic device, one or more text inputs from a user; and
using the on-device LLM to generate the text prompts based on the one or more text inputs and the ML outputs.

7. The method of claim 6, wherein generating the 360° multimodal wallpaper comprises inputting the text prompts into at least one of the one or more generative models based on an output modality requested in the one or more text inputs, the ML outputs, or both.

8. A system, comprising:
an electronic device comprising a processor, the processor configured to cause the electronic device to:
obtain a multimodal input using at least one sensor;
convert the multimodal input into encoded features;
adjust the encoded features to produce machine learning (ML) outputs based on user profiles, web browser data, and behavior patterns using an ML model;
generate text prompts based on the ML outputs using an on-device large language model (LLM);
generate a 360° multimodal wallpaper based on the text prompts from the on-device LLM using one or more generative models; and
refine the text prompts from the on-device LLM based on ongoing sensor data and user interaction using a feedback loop between an output of the one or more generative models and the on-device LLM.

9. The system of claim 8, wherein the processor is further configured to cause the electronic device to update the 360° multimodal wallpaper based on subsequent multimodal input received using the one or more sensors.

10. The system of claim 8, wherein the multimodal input comprises one or more of GPS data, ambient light data, motion data, and physiological sensor data.

11. The system of claim 8, wherein the encoded features comprises feature vectors from the multimodal input, user preferences, and device usage behavior.

12. The system of claim 11, wherein the processor, when causing the electronic device to generate the text prompts, is further configured to cause the electronic device to aggregate the feature vectors using the on-device LLM.

13. The system of claim 8, wherein the processor, when causing the electronic device to generate the text prompts, is further configured to cause the electronic device to:
receive one or more text inputs from a user; and
use the on-device LLM to generate the text prompts based on the one or more text inputs and the ML outputs.

14. The system of claim 13, wherein the processor, when causing the electronic device to generate the 360° multimodal wallpaper, is further configured to cause the electronic device to input the text prompts into at least one of the one or more generative models based on an output modality requested in the one or more text inputs, the ML outputs, or both.

15. A non-transitory computer-readable medium comprising program code, that when executed by at least one processor of an electronic device, causes the electronic device to:
obtain a multimodal input using at least one sensor;
convert the multimodal input into encoded features;
adjust the encoded features to produce machine learning (ML) outputs based on user profiles, web browser data, and behavior patterns using an ML model;
generate text prompts based on the ML outputs using an on-device large language model (LLM);
generate a 360° multimodal wallpaper based on the text prompts from the on-device LLM using one or more generative models; and
refine the text prompts from the on-device LLM based on ongoing sensor data and user interaction using a feedback loop between an output of the one or more generative models and the on-device LLM.

16. The non-transitory computer-readable medium of claim 15, wherein the program code further comprises program code, that when executed by the least one processor of the electronic device, is further configured to cause the electronic device to update the 360° multimodal wallpaper based on subsequent multimodal input received using the one or more sensors.

17. The non-transitory computer-readable medium of claim 15, wherein the multimodal input comprises one or more of GPS data, ambient light data, motion data, and physiological sensor data.

18. The non-transitory computer-readable medium of claim 17, wherein the encoded features comprises feature vectors from the multimodal input, user preferences, and device usage behavior and wherein the program code, that when executed by the at least one processor, causes the electronic device to generate the text prompts, comprises program code, that when executed by the at least one processor, causes the electronic device to aggregate the feature vectors using the on-device LLM.

19. The non-transitory computer-readable medium of claim 17, wherein the program code, that when executed by the at least one processor, causes the electronic device to generate the text prompts, comprises program code, that when executed by the at least one processor, causes the electronic device to:
receive one or more text inputs from a user; and
use the on-device LLM to generate the text prompts based on the one or more text inputs and the ML outputs.

20. The non-transitory computer-readable medium of claim 19, wherein the program code, that when executed by the at least one processor, causes the electronic device to generate the 360° multimodal wallpaper, comprises program code, that when executed by the at least one processor, causes the electronic device to input the text prompts into at least one of the one or more generative models based on an output modality requested in the one or more text inputs, the ML outputs, or both.
